(19) United States
(12) Patent Application Publication
(10) Pub. No.: US 2016/0082999 A1
(43) Pub. Date: Mar. 24, 2016

(54) Trolley for shopping in malls and shopping centers

(71) Applicant: Ana OBRADORS GÓMEZ, Madrid (ES)

(72) Inventor: Ana OBRADORS GÓMEZ, Madrid (ES)

(21) Appl. No.: 14/771,863

(22) PCT Filed: Feb. 22, 2014
(86) PCT No.: PCT/ES2014/070134

§ 371 Date: Sep. 1, 2015

(30) Foreign Application Priority Data
Mar. 4, 2013 (ES) P201330306

(51) Int. Cl. B62B 3/10; B62B 3/12

(52) U.S. Cl. CPC B62B 3/106; B62B 3/12

(57) ABSTRACT

Trolley for shopping in malls and shopping centers with a system of rods with safety for the bags and items transport.

The current invention refers to a trolley for shopping in Malls and Shopping Centers, it will be used to place the successive bags acquired in the Mall shops

### TECHNOLOGY AREA

The invention belongs to SECTION B PERFORMING OPERATIONS; TRANSPORTING, more precisely in transports referred to hand carts having more than one axis carrying transport wheels characterized by provisions for nesting or stacking e.g. shopping trolleys

### PRIOR ART

Nowadays in malls there are no means to transport purchases through this long spaces. It's really uncomfortable to have to walk long distances loaded with the purchases, coats, bags and other accessories, as well as a danger for people with backache which can increase this problems because of the weight.

Patent document intends a cart for this same purpose that apparently does not have the same characteristics as the one proposed in this application. System to hang the shopping bags is to hang them at the sides of this truck which can be quite unstable and inadequate.

### BACKGROUND OF THE INVENTION

We are all aware of supermarkets and hypermarkets trolleys, they are equipped with wheels and a case opened by the top to deposit inside the objects that will then be paid in register. According to the International classification: B62B3/14 (2006.01).

But this type of trolley is not useful for shopping centers or malls, where you have to get inside the different stores with confined spaces and low mobility.

### INVENTION DESCRIPTION

The trolley is designed so customers do not have to be loaded all through the Mall. When arriving to a Mall the customer will be able to pick a trolley so as to leave all purchases on it without having to walk loaded all over. It will also be useful to carry our winter clothes really bothering when visiting the different stores and when walking up and down the long corridors. It also makes easier when it comes to pick up the mobile phone or caring for children who accompany us.

### BRIEF DESCRIPTION OF DRAWINGS

Some drawings are accompanied to the better understanding of what is described in this report.

FIG. 1 is the rear view of the car

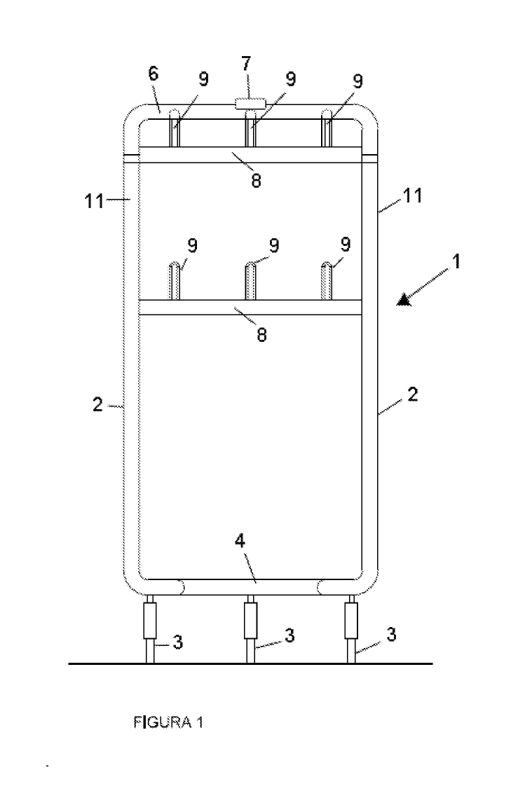

FIG. 2 is a side view of the same

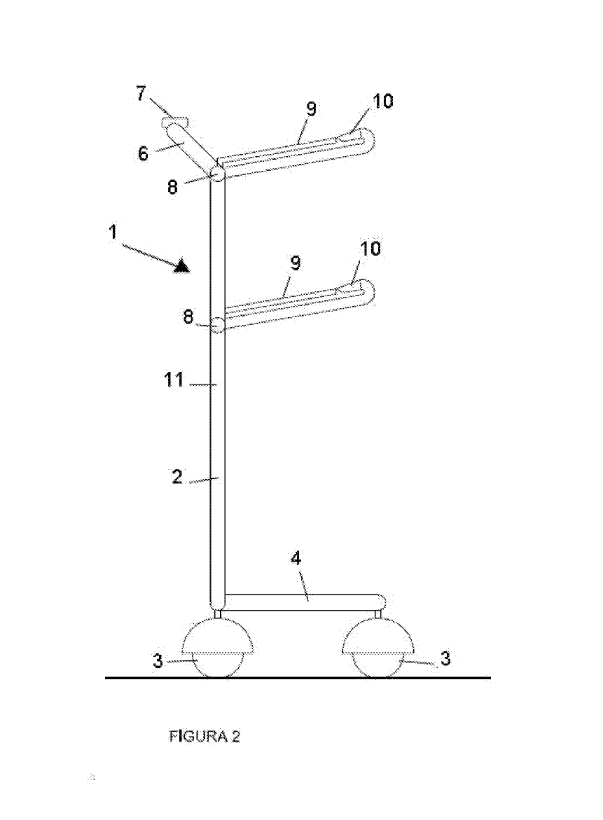

FIG. 3 is a view from the base of the cart without upper rods

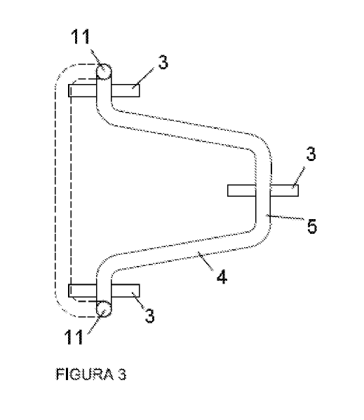

FIG. 4 is an overhead view devoid of wheels

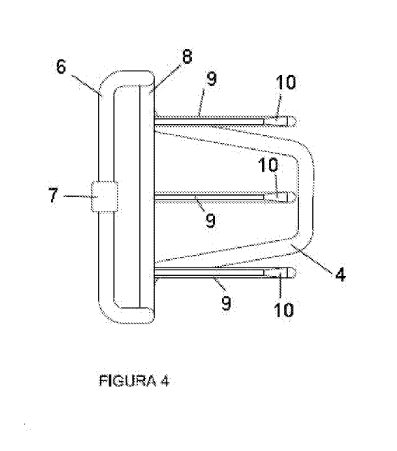

FIG. 5 is a side view of the accumulation system

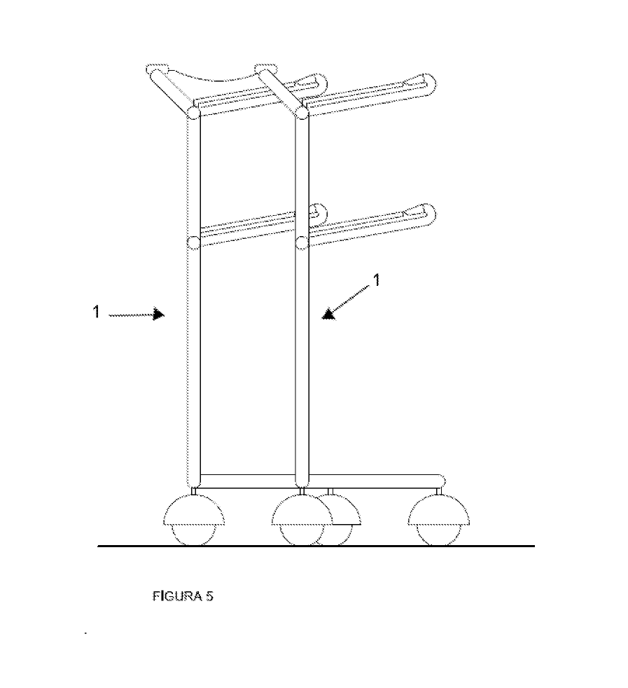

FIG. 6 floor view of the accumulation system view

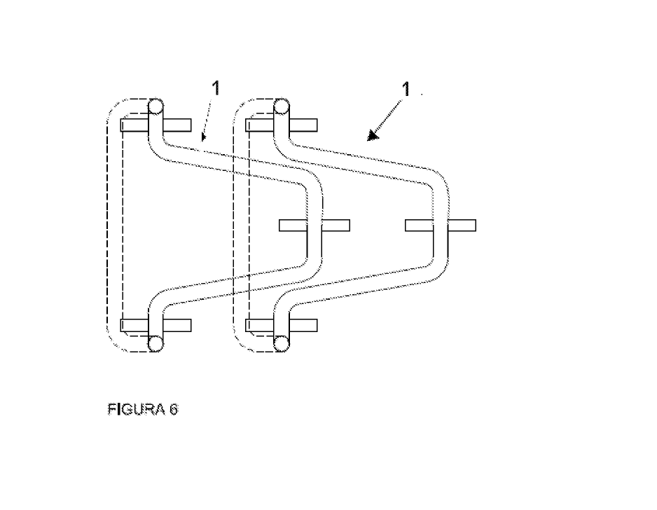

FIG. 7 is a perspective view

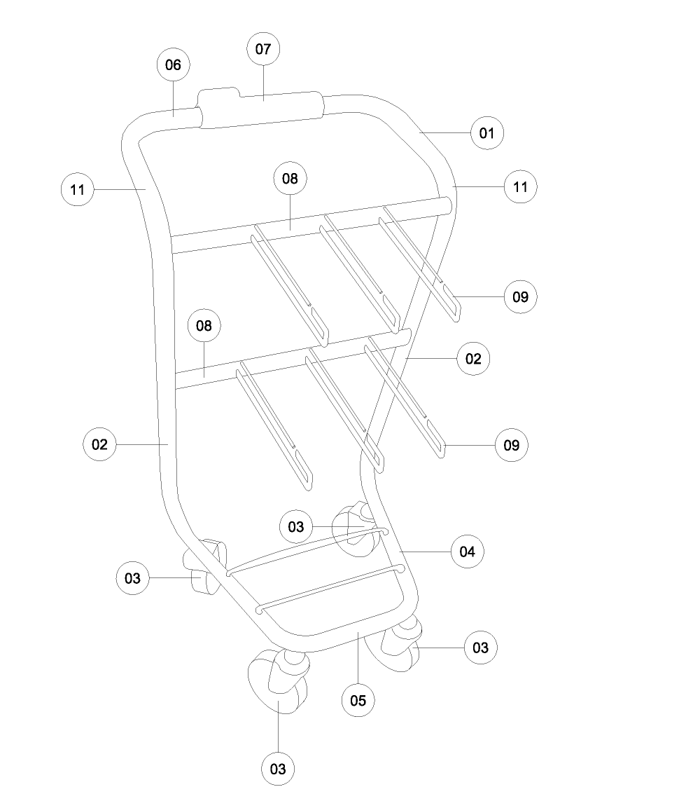

FIG. 8 is a perspective view

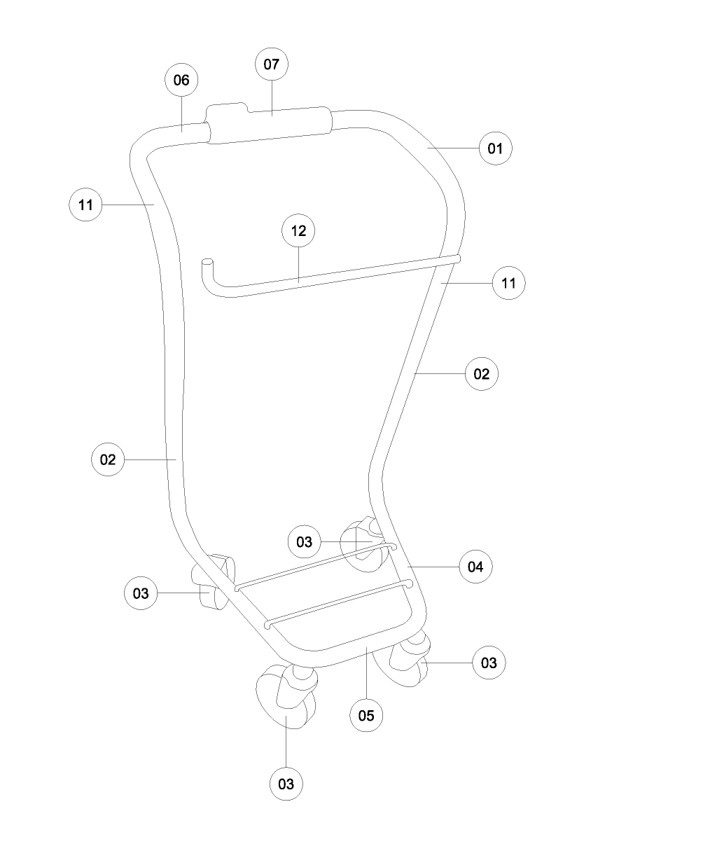

### DETAILED DESCRIPTION OF THE INVENTION

This trolley (1) has a L shape frame (2) provided with swivel wheels (3) (adapted for conveyors) at the base (4); in the front part of the base (4) there are rubber protectors (5) so the trolley (1) doesn't get damaged in the accumulation system. On the upper vertical area (11) of the L shaped frame (2) is the managing bar (6) of the trolley (1) equipped with a control system (7). This vertical area (11) is separated by at least two horizontal axes (8) from which arises three rods (9) respectively, these rods (9) function is to hold the bags of different sizes that they give you when you buy in the different stores of the shopping centers. These rods (9) are fitted with a closing (10) that prevents that bags can be extracted easily, which reverts in the safety of purchases (so as no one can take shopping with a simple gesture). This system (8) and (9) can be replaced by a single horizontal bar (12) attached to the frame (2) by its upper vertical end, curved at its own end to make it easier to leave the bags. The size of the trolley (1) does not exceed in its frontal part 50 cm (long) and 120 cm high, which makes it very easy to use and slightly clogs in stores where customers amble along with baby buggy much bigger than the trolley. It may have or not a braking system controlled from the bar (6) management of the trolley (1). The material for the manufacturing of the trolley (1) may include any known material or to know where design is effective (aluminum, iron, PVC, and others).

### DETAILED EXPLANATION OF EXECUTION WAY

The trolley (1) will be manufactured in iron with a mould designed of the prototype and the mould should be in one only piece or by parts, including the L shape frame (2) with its base (4) and (5), the managing bar (6), the horizontal axes (8)) with its rods (9) and (10) and the vertical area (11). Another way for the execution refers to the horizontal bar (12) weld to the frame (2) in one of the vertical sides, ended in an upside curve, that replaces the horizontal axes (8) and the rods (9). It will be painted or chrome plating depending on the mall needs. Afterwards the wheels (3) will be added two in to back and one or two in the front. The wheels (3) have to be swivel and adapted for conveyors. There should be added the control system (7) on the trolley (1) managing bar (6).

1. Trolley (1) for shopping in malls and shopping centers that includes an L shaped frame (2) with at least 3 swivel wheels (3) adapted for conveyors, characterized by the L shaped frame (2) is heavier on its base and specially on its front part, it's also provided with a vertical area (11) divided by at least two horizontal axes (8) from which arises three rods (9) respectively fitted with a closing (10) for bags it also includes a managing bar (6) of the trolley (1) equipped with a control system (7) on the upper vertical area.

2. Trolley (1) for shopping in malls and shopping centers, as in claim 1, provided by four swivel wheels (3) on the base (4), adapted for conveyors.

3. Trolley (1) for shopping in malls and shopping centers, as in claim 1 or 2, divided by three horizontal axes (8) from which arises three rods (9) each.

4. Trolley (1) for shopping in malls and shopping centers, as in claim 1 or 2, with an improved rod system (8 and 9) (drawing 8)

5. Trolley (1) for shopping in malls and shopping centers, as in claim 1, 2 or 4, which has a front dimension that doesn't exceed 50 cm and a height dimension not exceeding 120 cm.
